(19) United States
(12) Patent Application Publication
(10) Pub. No.: US 2026/0049679 A1
(43) Pub. Date: Feb. 19, 2026

(54) Pipe Gasket Including Annular Reinforcing/Stiffening Ring Encapsulated Within Flexible Gasket Body

(71) Applicant: Press-Seal Corporation, Fort Wayne, IN (US)

(72) Inventor: Jimmy Dean Gamble, Kendallville, IN (US)

(73) Assignee: Press-Seal Corporation, Fort Wayne, IN (US)

(21) Appl. No.: 19/290,436

(22) Filed: Aug. 5, 2025

Related U.S. Application Data
(60) Provisional application No. 63/682,602, filed on Aug. 13, 2024.

(51) Int. Cl. F16L 21/03

(52) U.S. Cl. CPC F16L 21/03

(57) ABSTRACT

A reinforced gasket for use in a Rieber joint can include a flexible annular gasket body and a reinforcing/stiffening ring. The flexible annular gasket body can include a leading nose section, a trailing tail section, and a radial tip section. The reinforcing/stiffening ring can include an inner diameter cylindrical wall having a leading edge and a trailing edge, and an annular angled front wall extending from the leading edge of the inner diameter cylindrical wall. The flexible annular gasket body can be molded around and encapsulates the reinforcing/stiffening ring. The leading edge of the inner diameter cylindrical wall can extend into the leading nose section, the annular angled front wall can extend into the radial tip section, and the trailing edge of the inner diameter cylindrical wall can extend into the trailing tail section. Preferably, the reinforced gasket includes stiffening ribs extending between the cylindrical wall and angled front wall.

### CROSS REFERENCE TO RELATED APPLICATION

This application claims benefit under 35 U.S.C. 119 (e) to provisional application Ser. No. 63/682,602 filed on Aug. 13, 2024, the disclosure of which is hereby incorporated by reference.

### BACKGROUND OF THE INVENTION

### 1. Field of the Invention

The present invention relates to pipe gaskets. More particularly, the present invention is directed to a pipe gasket used for a Rieber joint, the pipe gasket including an annular reinforcing/stiffening ring encapsulated within a flexible gasket body.

### 2. Background

A Rieber joint is a common type of pipe joint used for coupling pipes together end-to-end. In a Rieber joint, the female end of a first pipe includes a radially expanded cylindrical section (referred to as the “bell”) and an annular groove (referred to as the “bell groove”) formed inside of the bell. A reinforced gasket is mounted within the bell groove during formation of the bell and bell groove. Traditionally, the gasket includes an internal or external reinforcing ring and a flexible gasket body. The reinforcing ring provides structural support and pre-compresses the flexible gasket body against the first pipe. When the spigot (male end) of a second pipe is then inserted into the bell of the first pipe, the flexible gasket body is compressed between the two pipes and prevents fluid leakage therebetween.

As mentioned above, the reinforced gasket is mounted during formation of the bell and bell groove. Specifically, the reinforced gasket is first received over a cylindrical mandrel. The female end of a pipe is then heated up and stretched over the cylindrical mandrel and the reinforced gasket. The cylindrical mandrel has a larger diameter than the female end of the pipe and, when the female end is stretched over the mandrel, the female end radially expands, forming the bell. Thereafter, the female end is cooled (typically by spraying cool water over the pipe) which causes the female end to shrink. As the female end shrinks, the pipe deforms around the reinforced gasket which simultaneously forms the bell groove and captures the reinforced gasket therein. Of course, the bell groove is a mirror image of the reinforced gasket which ensures a fluid tight seal between the reinforced gasket and the bell groove.

The advantage of a Rieber joint, as opposed to a traditional joint which used a non-reinforced, flexible rubber gasket, is that the reinforced gasket is effectively “locked-in” and is self-restrained within the bell groove. This significantly reduces the likelihood of dislodgment of the reinforced gasket from the bell groove during insertion of the spigot, which in turn improves the reliability of the joint. Additionally, pre-installing the reinforced gasket during the manufacturing process also prevents unintentional use of the wrong type of gasket which further improves the reliability of the joint.

There are a number of different types of reinforced gaskets which are used in Rieber joints. For example, reinforced gaskets used in Rieber joints are shown and described in Bichler, U.S. Pat. No. 11,703,166; Pacheco et al., U.S. Pat. No. 11,287,072; and Montiel et al., U.S. Pat. No. 9,593,787.

However, traditional reinforced gaskets have a number of limitations. For example, the flexible gasket bodies of traditional reinforced gaskets are susceptible to damage when the pipe female end is stretched over the mandrel and gasket during the pipe manufacturing process. Accordingly, there exists a need for an improved reinforced gasket.

### SUMMARY OF THE INVENTION

In the present invention, a reinforced gasket for use in a Rieber joint can include a flexible annular gasket body and a reinforcing/stiffening ring. The flexible annular gasket body can include a leading nose section, a trailing tail section, and a radial tip section. The reinforcing/stiffening ring can include an inner diameter cylindrical wall having a leading edge and a trailing edge, and an annular angled front wall extending from the leading edge of the inner diameter cylindrical wall. The flexible annular gasket body can be molded around and encapsulates the reinforcing/stiffening ring. The leading edge of the inner diameter cylindrical wall can extend into the leading nose section, the annular angled front wall can extend into the radial tip section, and the trailing edge of the inner diameter cylindrical wall can extend into the trailing tail section.

Preferably, the reinforcing/stiffening ring includes one or more stiffening ribs which are provided extending radially between the inner diameter cylindrical wall and the annular angled front wall. Yet more preferably, the reinforcing/stiffening ring includes a plurality of regularly spaced stiffening ribs and a plurality of window openings which are provided through the annular angled front wall between each of the stiffening ribs.

Preferably, the reinforcing/stiffening ring includes a tail support wall which extends from the trailing edge of the inner diameter cylindrical wall. The tail support wall extends into the trailing tail section. Preferably, one or more cutouts are provided extending axially through the tail support wall.

Preferably, the flexible gasket body further comprises one or more axially extending front depressions along the leading nose section whereby the inner diameter cylindrical wall leading edge is exposed and one or more axially extending rear depressions along the trailing tail section whereby the tail support wall is exposed.

### BRIEF DESCRIPTION OF THE DRAWINGS

The above-mentioned and other features of this invention and the manner of attaining them will become more apparent, and the invention itself will be better understood by reference to the following description of the embodiments of the invention, taken in conjunction with the accompanying drawings, wherein:

FIG. 1 is a perspective view of a reinforced gasket;

FIG. 2 is an exploded perspective view showing the female end of a first pipe, the male end (spigot) of a second pipe, and a reinforced gasket;

FIG. 3A is a side elevation view of the first and second pipes coupled together;

FIG. 3B is a section view taken along the line 3B-3B shown in FIG. 3A;

FIG. 4A is a perspective view of a reinforcing/stiffening ring;

FIG. 4B is a magnified detail view of Circled Detail 4B shown in FIG. 4A;

FIG. 5A is another perspective view of the reinforcing/stiffening ring;

FIG. 5B is a magnified detail view of Circled Detail 5B shown in FIG. 5A;

FIG. 6A is a side elevation view of the reinforced gasket shown in FIG. 1;

FIG. 6B is a magnified detail view of Circled Detail 6B shown in FIG. 6A;

FIG. 6C is a magnified detail view of Circled Detail 6C shown in FIG. 6A;

FIG. 6D is a top plan view of the reinforced gasket;

FIGS. 7A-E are section views of the reinforced gasket taken along the lines 7A-7A, 7B-7B, 7C-7C, 7D-7D, and 7E-7E shown in FIG. 6D;

FIG. 8 is a side elevation view showing a reinforced gasket and a back-up collar mounted on a mandrel and a pipe adjacent the tapered terminal end of the mandrel;

FIG. 9 is a side elevation view of the pipe stretched over the mandrel;

FIGS. 10A-B are section views of the pipe, reinforced gasket, back-up collar, and mandrel; and

FIG. 10C is a section view of the pipe, reinforced gasket, and mandrel wherein the back-up collar has been retracted.

Corresponding reference characters indicate corresponding parts throughout several views. Although the exemplification set out herein illustrates certain embodiments of the invention, the embodiments disclosed below are not intended to be exhaustive or to be construed as limiting the scope of the invention to the precise form disclosed.

### DETAILED DESCRIPTION OF THE PREFERRED EMBODIMENTS

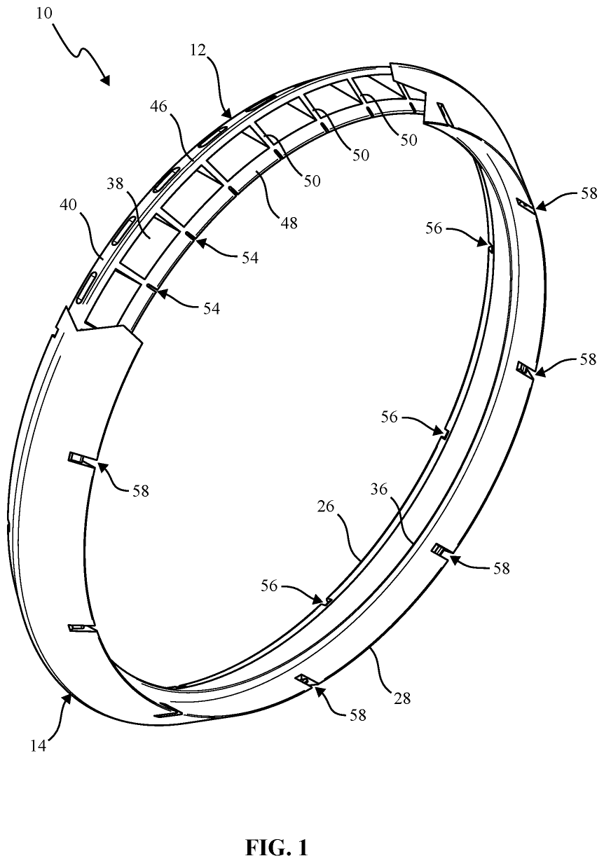

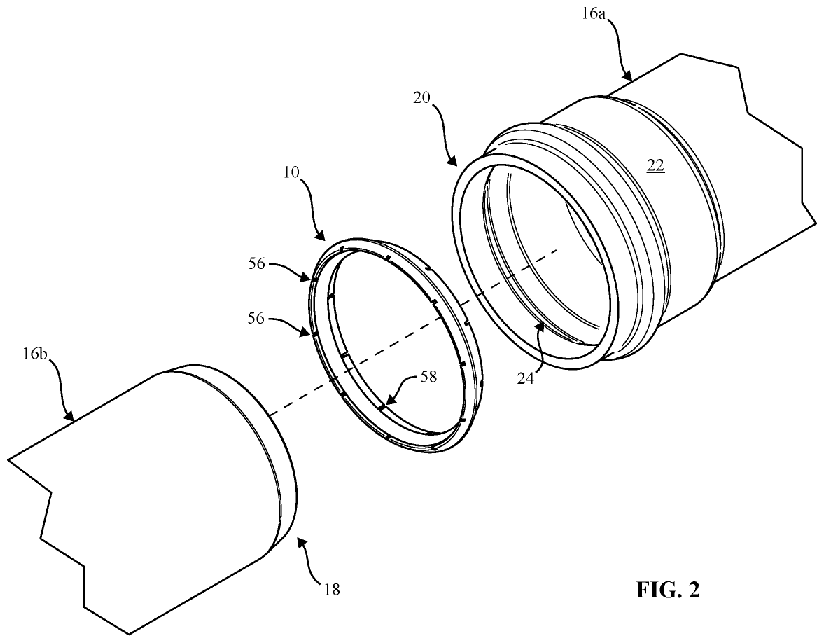

Referring initially to FIGS. 1-7, a reinforced gasket constructed in accordance with the principles of the present invention is designated by the numeral 10. The reinforced gasket 10 includes an annular reinforcing/stiffening ring 12 which is encapsulated within a flexible, annular gasket body 14. The reinforced gasket 10 is adapted to be used in a Rieber joint. A Rieber joint is a type of pipe joint that is commonly used to couple a plurality of pipes 16 together end-to-end to form a pipeline. Each pipe 16 includes a male end 18 (referred to as the spigot 18) and a female end 20. As best seen in FIG. 2, the female end 20 includes a radially expanded cylindrical section 22 (referred to as the “bell”) that is sized to receive the spigot 18. A reinforced gasket 10 is mounted within the bell 22 in an annular bell groove 24 formed therein. When the spigot 18 is inserted into the bell 22, the flexible gasket body 14 is compressed between the spigot 18 and the bell 22 for forming a fluid tight seal therebetween.

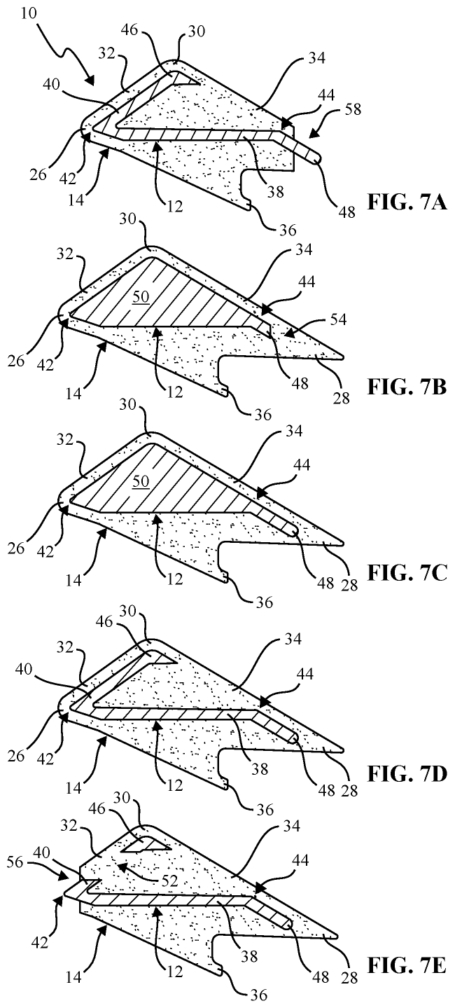

As best seen in FIGS. 7A-D, the flexible gasket body 14 is generally triangular in cross section and includes a leading nose section 26, a trailing tail section 28, and an outer radial tip section 30. The flexible gasket body 14 also includes a leading gasket wall 32 which is formed between the leading nose section 26 and the outer radial tip section 30, a trailing gasket wall 34 which is formed between the trailing tail section 28 and the outer radial tip section 30, and an inner annular wedge section 36 which extends radially inwardly from the gasket body 14 between the leading nose section 26 and the trailing tail section 28. Preferably, the flexible gasket body 14 is constructed from a flexible material, such as, for example, rubber, silicon, a thermoplastic elastomer (TPE) material, a thermoplastic vulcanizate (TPV) material, or other flexible elastic materials.

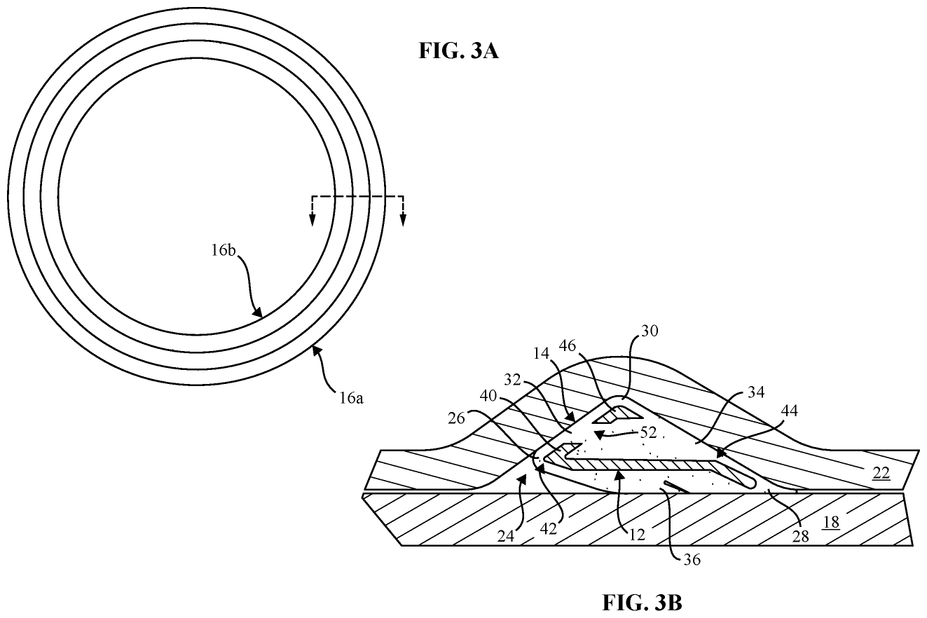

In use, as best seen in FIG. 3B, the outer radial tip section 30 and the leading and trailing gasket walls 32, 34 are adapted to engage and compress against the interior of a bell groove 24 of a first pipe 16a. When the spigot 18 of a second pipe 16b is inserted into the bell 22 of the first pipe 16a, the leading nose section 26, the trailing tail section 28, and the annular wedge section 36 are adapted to engage and compress against the spigot 18. By compressing against both the interior of the bell groove 24 and the spigot, the gasket body 14 forms a fluid tight seal between the first and second pipes 16a, 16b.

The reinforcing/stiffening ring 12 is, preferably, constructed from a plastic material, such as, for example, nylon, polypropylene, or other plastic materials, or a rigid or semi-rigid metallic material, such as, for example, stamped or cast steel, aluminum, titanium, or other metals or metal alloys. The reinforcing/stiffening ring 12 includes an inner diameter cylindrical wall 38 and an annular angled front wall 40 which extends from a leading edge 42 of the inner diameter cylindrical wall 38 (FIG. 7A). The cylindrical wall leading edge 42 extends into the gasket body leading nose section 26. The annular angled front wall 40 extends along the leading gasket wall 32 and into the radial tip section 30. The terminal end of the annular angled front wall 40 opposite the leading edge 42 is thickened and thereby forms an outer diameter annular ring 46 which is located within the gasket body radial tip section 30.

Preferably, the reinforcing ring 12 also includes a second annular angled wall 48 (referred to hereinbelow as the tail support wall 48). The tail support wall 48 extends from the trailing edge 44 of the inner diameter cylindrical wall 38 and extends into the gasket body tail section 28. The tail support wall 48 supports the gasket body tail section 28 and ensures a tight seal is formed when the spigot 18 of an adjacent pipe 16 is inserted into bell 22 and engages the gasket 10.

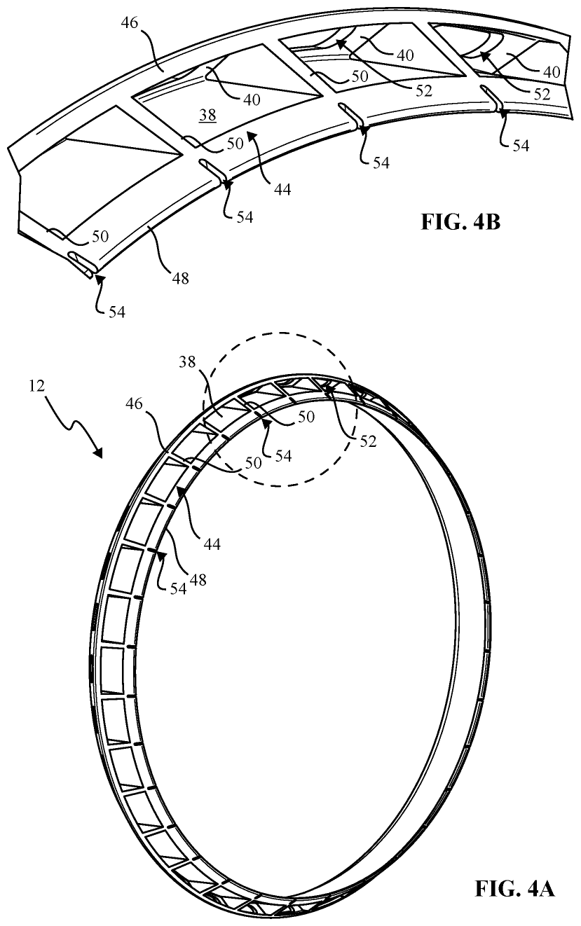

A plurality of stiffening ribs 50 are provided extending radially between the inner diameter cylindrical wall 38 and the annular angled front wall 40 (FIGS. 4A-B). The stiffening ribs 50 provide support for the annular angled front wall 40 and help to increase the structural rigidity of the reinforcing ring 12. The stiffening ribs 50 are also embedded into the flexible gasket body 14 to prevent the reinforcing ring 12 from sliding or rotating within the gasket body 14.

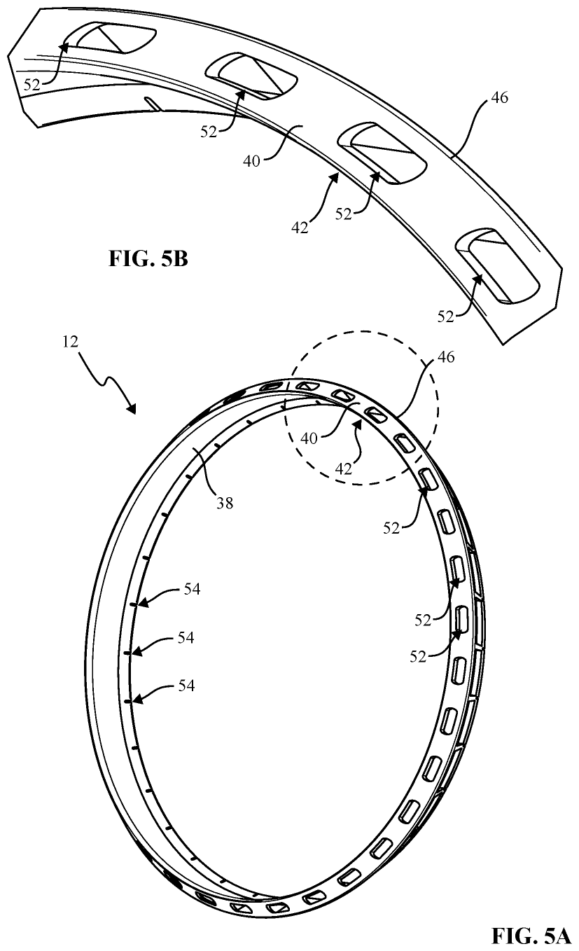

The reinforcing ring 12 also includes a plurality of window openings 52 which are provided through the annular angled front wall 40 between each of the stiffening ribs 50 (FIGS. 5A-B). When the flexible gasket body 14 is formed around the reinforcing ring 12, a portion of the gasket body material flows through and fills the window openings 52 for thereby further securing the gasket body 14 and the reinforcing ring 12 together.

Preferably, a cutout 54 is provided adjacent each stiffening rib 50 extending axially through the tail support wall 48. The cutouts 54 allow the tail support wall 48 to flex and expand as a spigot 18 engages and is received through the gasket 10. By allowing the tail support wall 48 to flex and expand, consistent pressure between the gasket body trailing tail section 28 and the spigot 18 is maintained which helps to prevent the gasket body trailing tail section 28 from pinching and/or tearing during installation of the spigot 18. After molding, the cutouts 54 are encapsulated within the gasket body 14.

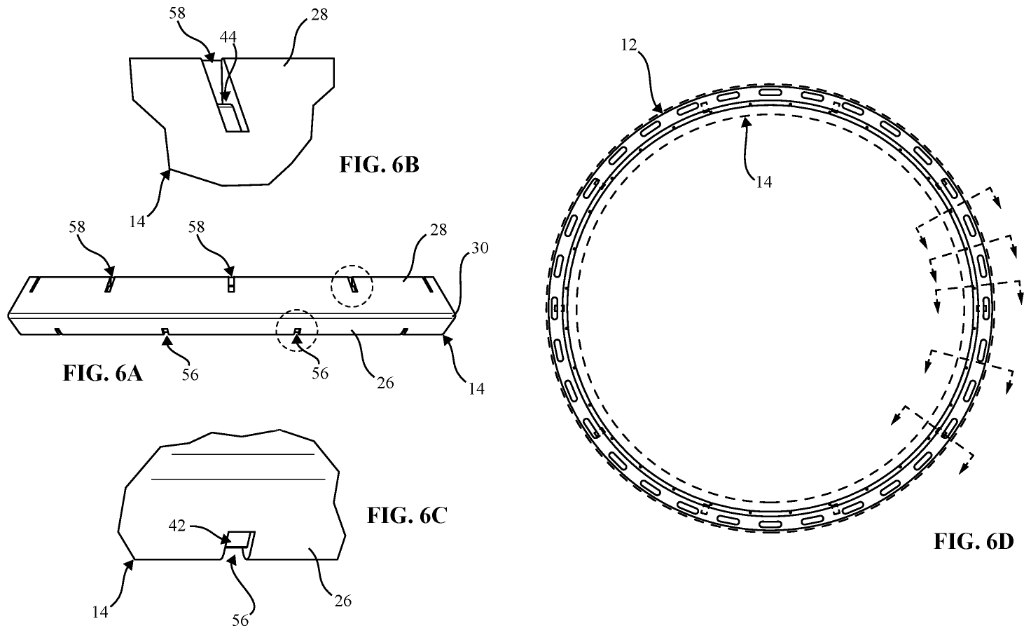

The reinforced gasket 10 is preferably assembled by injection molding, casting, or otherwise molding or forming the reinforcing ring 12 from a unitary material and then molding the gasket body 14 around the reinforcing ring 12. When molding the gasket body 14 around the reinforcing ring 12, the reinforcing ring is supported at spaced intervals along the mold interior surface (not shown) to ensure proper alignment within the mold. By supporting the reinforcing ring 12 in this manner, the rubber gasket body 14 is left with a plurality of axially extending front depressions 56 along the leading nose section 26 of the gasket body 14 thereby exposing the inner diameter cylindrical wall leading edge 52 (FIG. 6B), and a plurality of axially extending rear depressions 58 along the trailing tail section 28 of the gasket body 14 thereby exposing the tail support wall 48 (FIG. 6C).

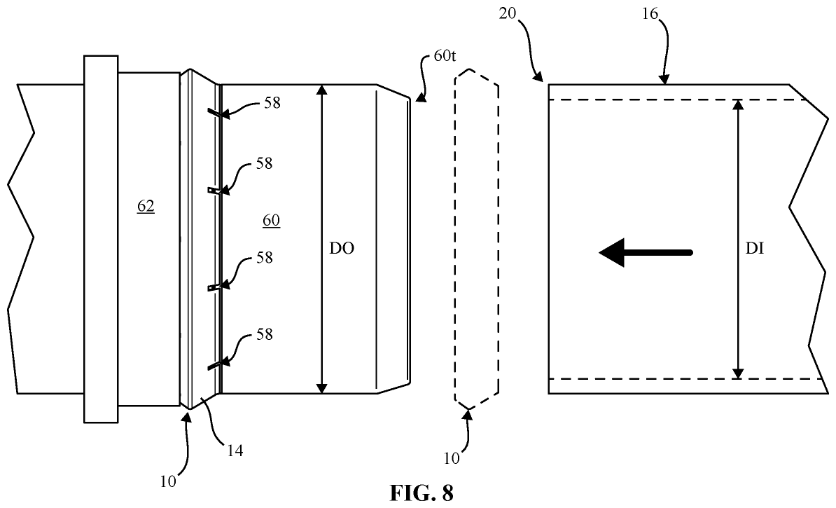

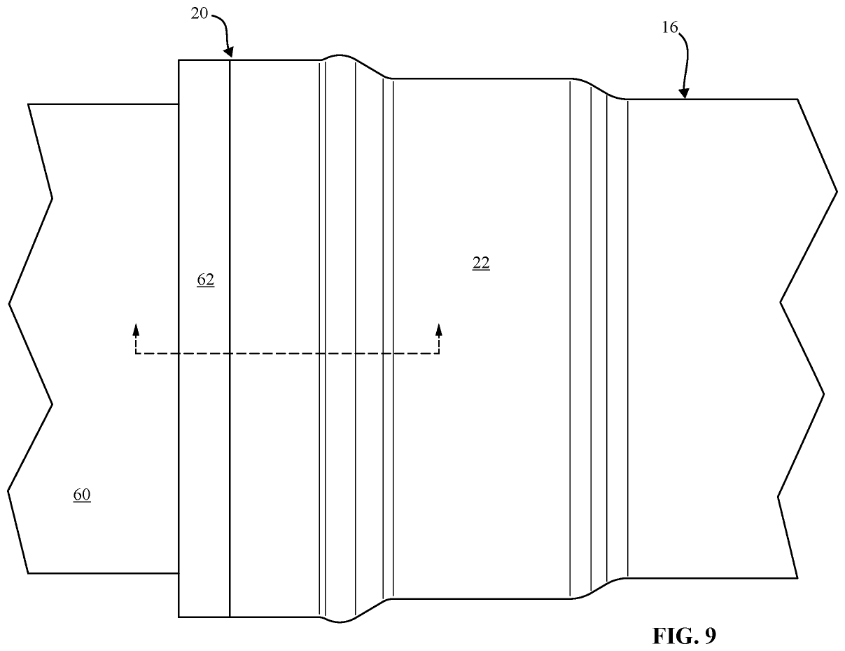

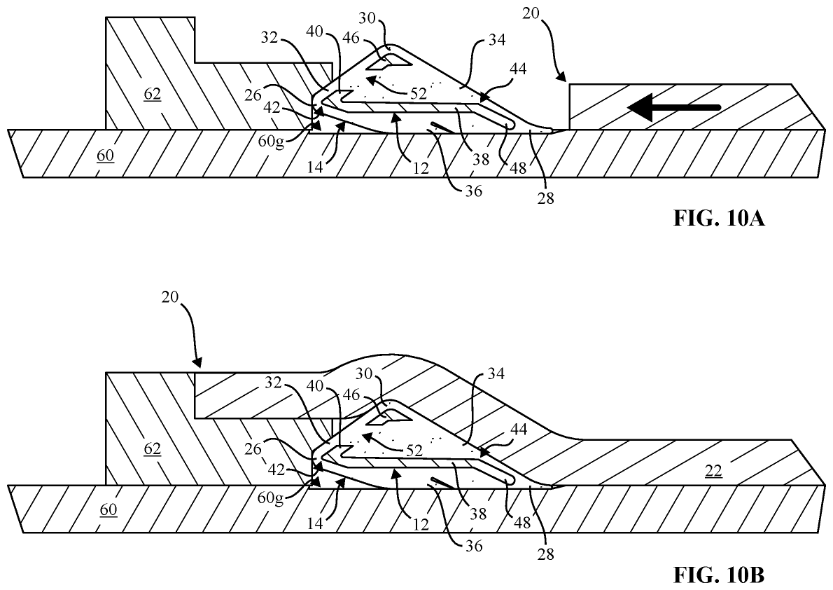

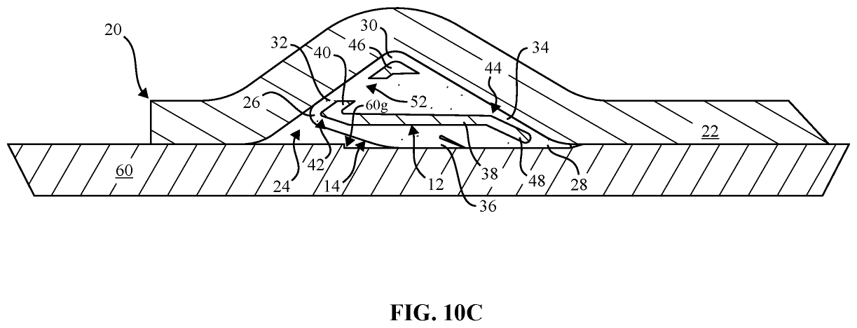

Turning to FIGS. 8-10, the reinforced gasket 10 is configured to be installed during formation of the bell 22 and bell groove 24. Specifically, the bell 22 and bell groove 24 are formed via a process commonly referred to as “belling”. In the belling process, the female end 20 of a pipe 16 is heated up until it is soft and malleable and then stretched over a cylindrical mandrel 60. The outer diameter DO of the mandrel 60 is greater than the inner diameter D1 of the pipe 16, and so, as the female end 20 is stretched over the cylindrical mandrel 60, the female end 20 radially expands around the mandrel 60, thereby forming the bell 22.

The reinforced gasket 10 is installed as part of the belling process by first slipping the reinforced gasket 10 over the tapered terminal end 60t of a cylindrical mandrel 60 and then seating the reinforced gasket into a shallow gasket receiving groove 60g. The gasket receiving groove 60g is sized such that, when the gasket 10 is seated into the groove, the annular wedge section 36 and the trailing tail section 28 are compressed against the mandrel 60. By compressing the annular wedge section 36 and the trailing tail section 28, the gasket 10 is placed under tension which automatically aligns the gasket with the mandrel 60.

Once the gasket 10 is in position, the pipe female end 20 is heated up until it is soft/malleable and is stretched over the mandrel 60 and the reinforced gasket 10. As the pipe female end 20 is stretch over the mandrel 60, it climbs over the gasket trailing tail section 28, up the trailing gasket wall 34, and over the gasket radial tip section 30. In this regard, the reinforcing ring tail support wall 48 is adapted to support and keep the trailing tail section 28 from being lifted away from the mandrel 60 which helps prevent the gasket body 14 from ripping or tearing as the pipe female end 20 is stretched thereover. Additionally, the tail support wall 48 supports a portion of the trailing gasket wall 34 and acts as a ramp which helps to direct the pipe female end 20 up and over the gasket 10.

Preferably, a back-up collar 62 is slidably mounted on the mandrel 60 and is positioned abutting the reinforced gasket 10 on the side opposite from the mandrel tapered terminal end 60t. The back-up collar 62 helps to hold the reinforced gasket 10 in position and supports the pipe female end 20 as it is stretched over the reinforced gasket. Once the pipe 16 has been stretched over the reinforced gasket 10 and is in the desired position, the collar 62 is retracted away from the reinforced gasket 10 and the pipe female end 20.

After or while the back-up collar 62 is being retracted, a vacuum is applied to the pipe female end 20 via ducts (not shown) in the mandrel 60. The vacuum draws the malleable female end 20 over and deforms the female end 20 around the reinforced gasket 10 for thereby forming the bell groove 24 and simultaneously capturing the reinforced gasket 10 therein. Applying a vacuum to the female end 20 ensures the bell groove 24 is formed tightly around, and is essentially a mirror image of, the reinforced gasket 10 which creates a fluid tight seal reinforced gasket 10 and the pipe 16. The pipe female end 20 is then cooled/solidified by, for example, spraying the pipe with a cooling water spray (not shown). Once the pipe female end 20 is sufficiently cooled/solidified, the pipe 16 can be withdrawn from the mandrel 60 and installed or transported to a work site for installation as part of a pipeline (not shown).

With respect to vacuum forming the female end 20 around the reinforced gasket 10, the reinforcing ring 12 provides support for and prevents the flexible gasket body 14 from being over compressed whereby the bell groove 24 would become too shallow. More particularly, the reinforcing ring cylindrical wall 38, annular angled front wall 40, outer diameter annular ring 46, and tail support wall 48 support the gasket body leading nose section 26, leading wall section, the outer radial tip section 30, and the trailing tail section 28 and prevent the gasket body 14 from being over compressed against the mandrel 60 by the forces generated when the vacuum is applied to the pipe female end 20 for drawing and forming the pipe female end around the reinforced gasket 10. If the gasket body 14 is allowed to compress too far, the bell groove 24, which mirrors the shape of the compressed gasket 10, will become too shallow which could cause the reinforced gasket 10 to dislodge from the bell groove 24 when a spigot 18 is inserted into the bell 22 and engages the reinforced gasket. Accordingly, by supporting the gasket body 14 such that it is not over compressed against the mandrel 60, the reinforcing ring 12 ensures that the bell groove 24 is sufficiently sized to hold the reinforced gasket 10 in place when the spigot 18 is inserted into the bell 22.

While this invention has been described as having an exemplary embodiment, the present invention may be further modified within the spirit and scope of this disclosure. This application is therefore intended to cover any variations, uses, or adaptations of the invention using its general principles.

What is claimed is:

1. A reinforced gasket for use in a Rieber joint, the reinforced gasket comprising:
a flexible annular gasket body having a leading nose section, a trailing tail section, and a radial tip section; and,
a reinforcing/stiffening ring including:
an inner diameter cylindrical wall having a leading edge and a trailing edge; and
an annular angled front wall extending from the leading edge of the inner diameter cylindrical wall;
wherein the flexible annular gasket body is molded around and encapsulates the reinforcing/stiffening ring; and,
wherein the leading edge of the inner diameter cylindrical wall extends into the leading nose section, the annular angled front wall extends into the radial tip section, and the trailing edge of the inner diameter cylindrical wall extends into the trailing tail section.

2. The reinforce gasket of claim 1, wherein the reinforcing/stiffening ring further comprises one or more stiffening ribs which are provided extending radially between the inner diameter cylindrical wall and the annular angled front wall.

3. The reinforced gasket of claim 1, wherein the reinforcing/stiffening ring further comprises one or more window openings which are provided through the annular angled front wall.

4. The reinforce gasket of claim 1, wherein the reinforcing/stiffening ring further comprises a plurality of regularly spaced stiffening ribs which are provided extending radially between the inner diameter cylindrical wall and the annular angled front wall.

5. The reinforced gasket of claim 4, wherein the reinforcing/stiffening ring further comprises a plurality of window openings which are provided through the annular angled front wall between each of the stiffening ribs.

6. The reinforced gasket of claim 1, wherein the reinforcing/stiffening ring further comprises a tail support wall extending from the trailing edge of the inner diameter cylindrical wall, and wherein the tail support wall extends into the trailing tail section.

7. The reinforced gasket of claim 6, wherein one or more cutouts are provided extending axially through the tail support wall.

8. The reinforced gasket of claim 7, wherein the flexible gasket body further comprises one or more axially extending front depressions along the leading nose section whereby the inner diameter cylindrical wall leading edge is exposed and one or more axially extending rear depressions along the trailing tail section 28 whereby the tail support wall is exposed.
